(19) United States
(12) Patent Application Publication
(10) Pub. No.: US 2013/0153719 A1
(43) Pub. Date: Jun. 20, 2013

(54) JOINT BAR SECURMENT DEVICE

(71) Applicant: Herb Weston, Amalga, UT (US)

(72) Inventor: Herb Weston, Amalga, UT (US)

(21) Appl. No.: 13/329,722

(22) Filed: Dec. 19, 2011

(51) Int. Cl. F16M 11/22

(52) U.S. Cl. 248/176.1

(57) ABSTRACT

A joint bar securement device is disclosed having a baseplate affixed to a plurality of elongated cylindrical metal upwardly-rising shafts. Joint bars are threaded onto the metal shafts, stacked one upon another, and secured during transport by the joint bar securement device. Some embodiments of the present invention further comprise cables, ropes, and/or chains detachably affixed to the metal shafts and the baseplate to prevent the joint bars from bouncing out of the securement device during transport. Other embodiments include lateral braces in place of the metal shafts for cradling the joint bars.

### BACKGROUND OF THE INVENTION

1. Field of the Invention

This invention relates to joint bars used in railroad construction, and more particularly relates to devices for securing joint bar during transport to construction sites.

2. Description of the Related Art

In the railroad industry, a joint bar, or fishplate, is a metal bar that is bolted to the ends of two rails to join them together in a track. The top and bottom edges of most joint bars are tapered inwards so the device wedges itself between the head and foot of the rail when the joint bar is bolted into place.

These joint bars usually comprise apertures for receiving bolts traversing the track and joint bars. Joint bars weight 30 to 100 pounds and are cumbersome to transport. Often, railroad employees and contractors transport them to the site of track repairs sitting loosely in the beds of trucks, where they slide and bounce during transport, endanger other employees, and risk damaging other vehicles. Recently, various state and federal agencies have warned railroad employees that joint bars must be secured in the beds of pick up trucks during transport and that continued transport of unsecured joint bars is unlawful.

The art teaches no efficient means of securing joint bars during transport. There exists a need in the art for a simple and effective device for securing joint bars during transport.

### SUMMARY OF THE INVENTION

From the foregoing discussion, it should be apparent that a need exists for a joint bar securement device. Beneficially, such a device would overcome many of the difficulties with prior art by providing a function device which is durable.

The present invention has been developed in response to the present state of the art, and in particular, in response to the problems and needs in the art that have not yet been fully solved by currently available apparatii and methods. Accordingly, the present invention has been developed to provide a portable, joint bar securement device comprising a rigid metal baseplate having a planar top surface; and a plurality of elongated cylindrical metal shafts rising orthogonally from the surface of the baseplate, the cylindrical shafts for threading through apertures defined by one or more joint bar(s), wherein a diameter of the cylindrical shafts is less than a diameter of the apertures defined by the joint bar(s), the joint bar(s) used in construction of railroad track, each of the metal shafts having have a proximal end affixed to the baseplate and an opposing distal end for penetrating joint bars threaded over the metal shafts. The joint bar securement device of claim 1, wherein one or more of distal end(s) of the metal shaft(s) define(s) a distal aperture.

The joint bar securement device may further comprise: a split ring threaded through the distal aperture(s) defined by the metal shaft(s); and one or more cable(s) affixed at one end to the baseplate and affixed detachably at an opposing end to one of the split rings to secure joint bars threaded over the metal shafts from bouncing off the metal shafts during transport.

The joint bar securement device may further comprise an elongated crossbar detachably affixed at a first end to the distal end of one of the metal shafts, the crossbar also detachably affixed at a second end to one of the metal shafts.

The apertures may be defined by the distal ends of the metal shafts receive and grip the crossbar.

The joint bar securement device may further comprise one or more of a cable, chain, and rope affixed at one end to the baseplate and affixed at an opposing end to the distal end of one of the metal shafts.

The joint bar securement device may further comprise a bar hingedly connected at a first end to the distal end of a first metal shaft, the bar lockably affixable at a second end to the distal end of a second metal shaft. In some embodiments, the joint bar securement device further comprises a bar hingedly connected at a first end to the distal end of a first metal shaft, the bar lockably affixable at a second end to the distal end of a second metal shaft.

One of the metal shafts may be slideably affixed to the baseplate such that a width between the metal shaft and other metal shafts is adjustable.

A second joint bar securement device is disclosed comprising: a rigid metal baseplate having a planar top surface; and an elongated cylindrical metal shaft rising orthogonally from the surface of the baseplate, the cylindrical shaft for threading through apertures defined by one or more joint bar(s), wherein a diameter of the cylindrical shaft is less than a diameter of the apertures defined by the joint bar(s), the joint bar(s) used in construction of railroad track, the metal shafts having have a proximal end affixed to the baseplate and an opposing distal end for penetrating joint bars threaded over the metal shafts; a left lateral side affixed to the baseplate comprising an elongated plate of metal having an inner planar surface rising orthogonally from the surface of the baseplate, the left lateral side affixed to the baseplate; and a right lateral side affixed to the baseplate comprising an elongated plate of metal having an inner planar surface rising orthogonally from the surface of the baseplate, the right lateral side affixed to the baseplate; wherein the left lateral side and right lateral side define a recess between them for receiving and securing a joint bar in the recess from moving laterally across the top surface of the baseplate.

A third joint bar securement device comprising: a rigid metal baseplate having a planar top surface; and a plurality of elongated cylindrical metal shafts rising orthogonally from the top surface of the baseplate, the cylindrical shafts for threading through apertures defined by one or more joint bar(s), wherein a diameter of the cylindrical shafts is less than a diameter of the apertures defined by the joint bar(s), the joint bar(s) used in construction of railroad track, each of the metal shafts having have a proximal end affixed to the baseplate and an opposing distal end for penetrating joint bars threaded over the metal shafts.

The joint bar securement device further comprises a lateral side affixed to the baseplate, the lateral side comprising a rectangular plate of metal disposed off-center of the baseplate having a proximal end affixed to the baseplate and an opposing distal end, the lateral side rising orthogonally away from the top surface of the baseplate; one or more hinge(s) affixed to the distal end of the lateral side; and a top plate affixed to the hinge(s), the top plate defining two or more recesses for receiving the distal ends of the metal shafts such that the top plate can be laid over joint bars threaded onto the metal shafts.

In some embodiments, the joint bar securement device further comprising a split ring detachably affixed to the distal end of a metal shaft. The joint bar securement device may further comprise one or more cables detachably affixed at a first end to the split ring and affixed at a second end to the top plate.

The joint bar securement device may further comprise one or more chains detachably affixed with a locking mechanism at a first end to distal end of a metal shaft, the chain(s) affixed at a second end to the top plate.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side elevational perspective view of a joint bar securement device in accordance with the present invention;

FIG. 2 is a side elevational perspective view of a joint bar securement device in accordance with the present invention;

FIG. 3 is a side elevational perspective view of a joint bar securement device in accordance with the present invention;

FIG. 4 is a side elevational perspective view of a joint bar securement device in accordance with the present invention;

FIG. 5 is a side elevational perspective view of a joint bar securement device in accordance with the present invention;

FIG. 6 is a side elevational perspective view of a joint bar securement device in accordance with the present invention; and

FIG. 7 is a side elevational perspective view of a joint bar securement device in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

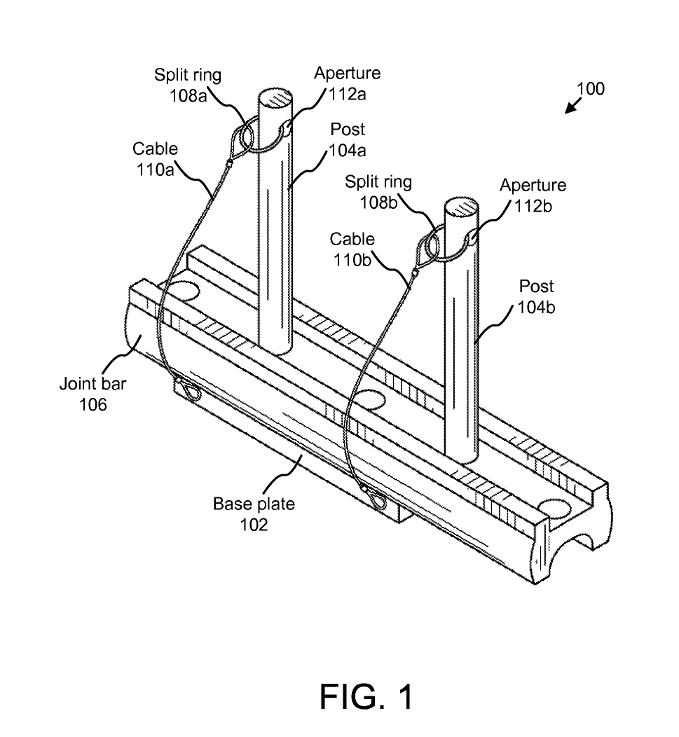

FIG. 1 is a side elevational perspective view of a joint bar securement device 100 in accordance with the present invention. The device 100 comprises a baseplate 102, a shaft 104a (i.e. post 104a), a shaft 104b (i.e. post 104b), a joint bar 106, a split ring 108a, a split ring 108b, a cable 110a, a cable 110b, an aperture 112a, and an aperture 112b.

The posts 104a-b, or shafts 104a-b, are fabricated, in the shown embodiment, from a rigid polymer, metal, carbon, alloy, wood, glass, elastomeric, and/or silastic material. The posts 104a-b comprise elongated, cylindrical shafts, rods, or bars which are affixed to the planar top surface of the baseplate 102. The shafts 104a-b rise orthogonally from the top[ surface of the baseplate 102.

The baseplate 102 comprises a sheet or block of metal, wood, or elastomeric material having a planar top surface. In some embodiments, the baseplate 102 is portable is and loosely fitted in the bed of pick up truck or flat bed utility truck. In other embodiments, the baseplate 102 is the bed of a pick up truck or flat bed utility truck. In those embodiments, the bed of the truck acts as the baseplate 102 and the posts 104a-b are affixed to the bed using means known to those of skill in the art, including screw/bolt mechanisms and/or welding.

The posts 104a-b comprise a proximal end which is affixed to the baseplate 102. The posts 104a-b also comprise an opposing distal end rising into the ambient air above the baseplate 102. In various embodiments, the distal end of the posts 104a-b define an aperture 112, recess, or hole running laterally through posts 104a-b. In the shown embodiments, the posts 104a-b define the apertures 112a-b respectively.

The baseplate 102, in some embodiments, may comprise elastomeric material. The baseplate 102 and posts 104a-b may formed through injection molding, 3D printing, cast, DMLS, machined, or stamped.

Two split rings 108a-b are threaded through the apertures 112a-b in the distal ends of the shafts 104a-b. These split rings 108a-b are detachably affixed to cables 110a-b which are affixed at opposing ends to the baseplate 102. The cables 110a-b serve to secure joint bars 106 threaded onto the posts 104a-b, and prevent the joint bars 106 from bouncing off the securement device 100 during transport.

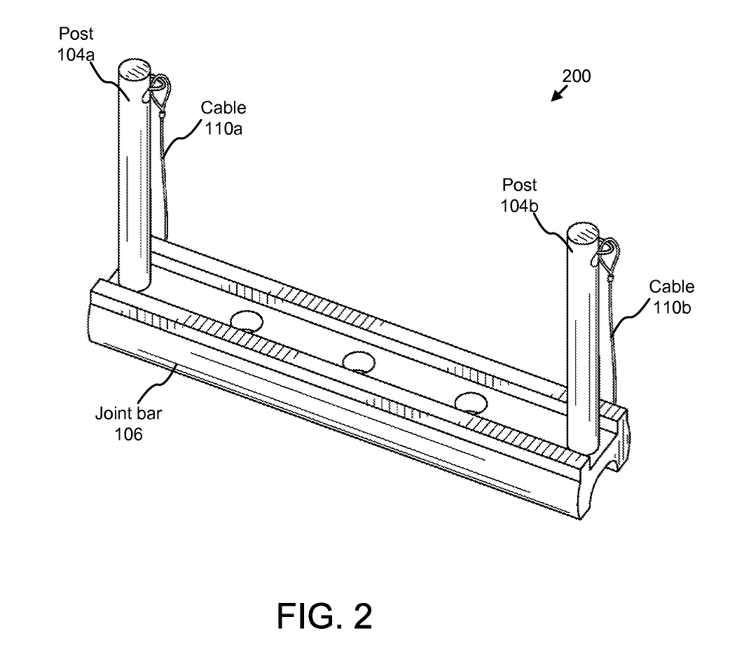

FIG. 2 is a side elevational perspective view of a joint bar securement device 200 in accordance with the present invention. The device 200 comprises a shaft 104a (i.e. post 104a), a shaft 104b (i.e. post 104b), and a joint bar 106.

The joint bar 106, posts 104a-b, and cables 110a-b each are substantially described above in relation to FIG. 1.

The securement device 200 is substantially similar to securement device 100, and shown an opposing side elevational view relative to FIG. 1.

The joint bars 106 comprises holes, apertures, bores, or recesses for receiving screw/bolt mechanism when joining track as shown.

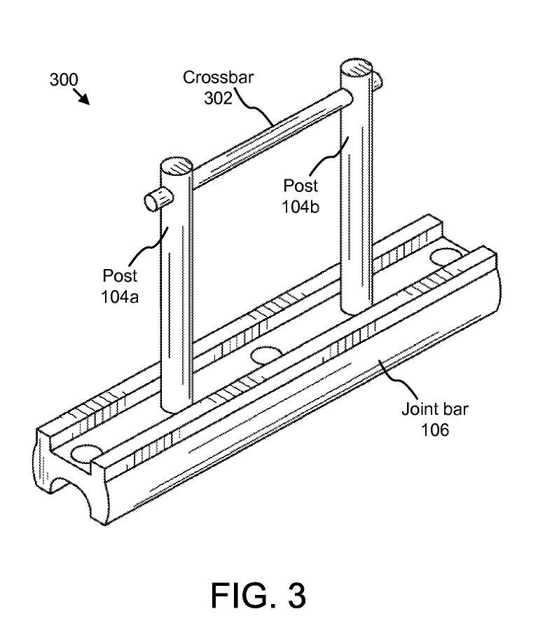

FIG. 3 is a side elevational perspective view of a joint bar securement device 300 in accordance with the present invention. The device 300 comprises a shaft 104a, a shaft 104b, and crossbar 302.

The crossbar 302 comprises an elongated cylindrical or tubular member affixed between the posts 104a-b. In the shown embodiment, the crossbar 302 is partially housed by apertures 112a-b, which are adjusted to fall in line with one another. In the shown embodiment, the crossbar 302 replaces the split rings 108a. FIG. 3 provides means of securing the joint bars 106 to the device 300 that is stronger than the cables 110a-b, and less likely the break. The joint bars 106 cannot bounce off the posts 104a-b during transit so long as the crossbar 302 is affixed in place between the posts 104a-b.

The crossbar 302 is detachable from both posts 104a-b. In some embodiments, the crossbar 302 is tethered with cable, rope, or chain to the baseplate 102.

In further embodiments, the crossbar 302 comprises a chain, cable, or rope strung through the apertures 112a-b between the posts 104a-b.

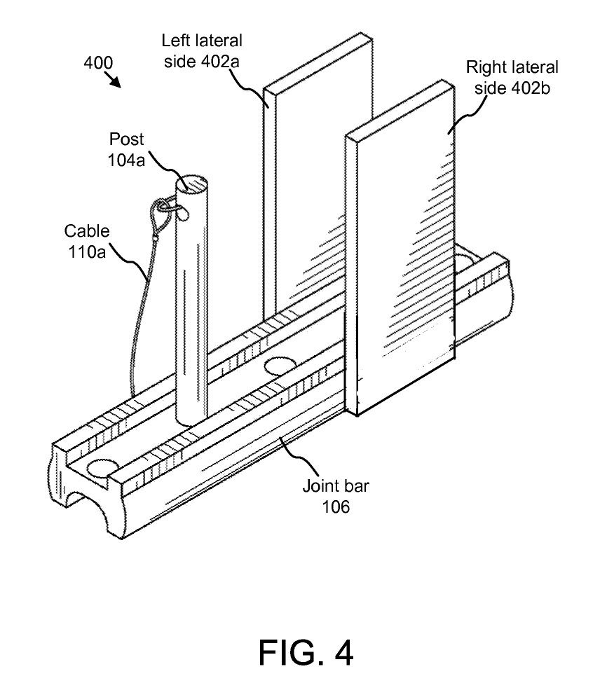

FIG. 4 is a side elevational perspective view of a joint bar securement device 400 in accordance with the present invention. The securement device 400 comprises a post 104a, a cable 110a, a left lateral side 402a, and a right lateral side 402b. A joint bar 106 is also shown.

Like devices 100-300, device 400 comprises a post 104a and cable 110a substantially described above in relation to FIGS. 1-3. Unlike earlier described embodiments, the device 400 comprises sides 402a-b, which rise upwardly from the baseplate 102 (not shown).

The sides 402a-b comprise slabs which form a recess between them for housing joint bars 106 during transit. The sides 402a-b may comprise plywood, metal and/or polymer sheets, bars, shafts, posts, or tubes. These side are affixed to the baseplate 102 sucht that jutt upwardly away from the baseplate 102. In some embodiments, the sides rise in parallel to on another and/or to the post 104a. In other embodiments, the distance between the sides 402a-b increases with their rise from the baseplate 102 such that they for a funnel, or slide, forcing joint bars 106 to the center between them as the joint bars 106 fall into place.

In some embodiments of the present invention, the device 400 comprises a second, third, or fourth set of sides 402a-b in place of the post 104a. In other embodiments, the sides 402a-b extend sufficiently across the length or breadth of the baseplate 102 such that only one set of the sides 402a-b is necessary to effectively secure the joint bars 106.

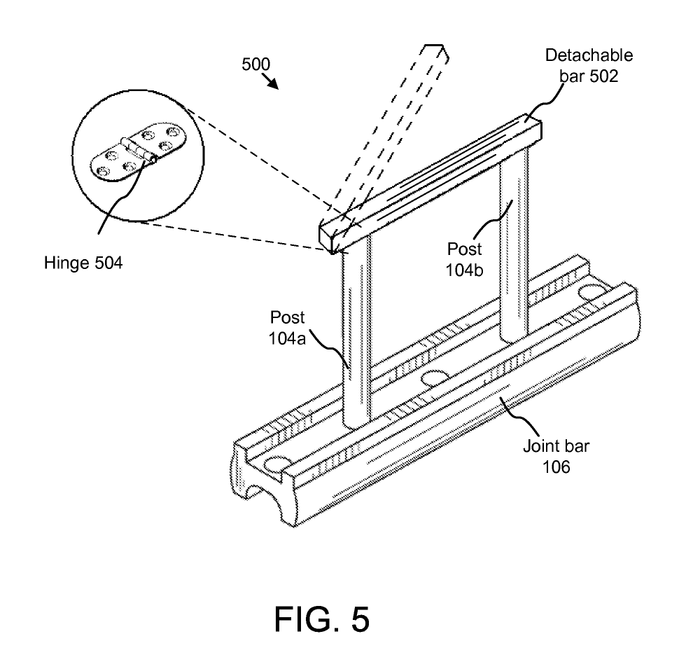

FIG. 5 is a side elevational perspective view of a joint bar securement device 500 in accordance with the present invention. The securement device 500 comprises posts 104a-b, a detachable bar 502, and a hinge 504. A joint bar 106 is also shown.

The posts 104a-b and joint bar 106 are substantially described above in relation to FIGS. 1-4. The detachable bar 502, like the crossbar 302, detachably interconnects the posts 104a-b to secure joint bars 106 during transport after they are threaded onto the posts 104a-b. In the shown embodiment, however, the detachable bar 502 affixed to the distal ends of the posts 104a-b, rather than through the apertures 112a-b. The detachable bar 502 may detachably affixed to one or more of the distal ends using a hinge 504, a screw/bolt mechanism, threading, or via other means known to those of skill in the art.

In some embodiments, the detachable bar 502 locks onto the distal ends of the posts 104a-b using clamps, buckles, snaps, brackets, or other means known to those of skill in the art. In some embodiments, the detachable bar 502 comprises an extension of the post 104a which is hingedly attached. In those embodiments, the detachable bar 502 is pointed upward in line with the post 104a. The joint bars 106 are threaded over the posts 104a-b, after which the detachable bar 502 is folded over the joint bars 106 and locked using means known to those of skill in the art to the distal end of the post 104b.

The hinge 504 is well known to those of skill in the art.

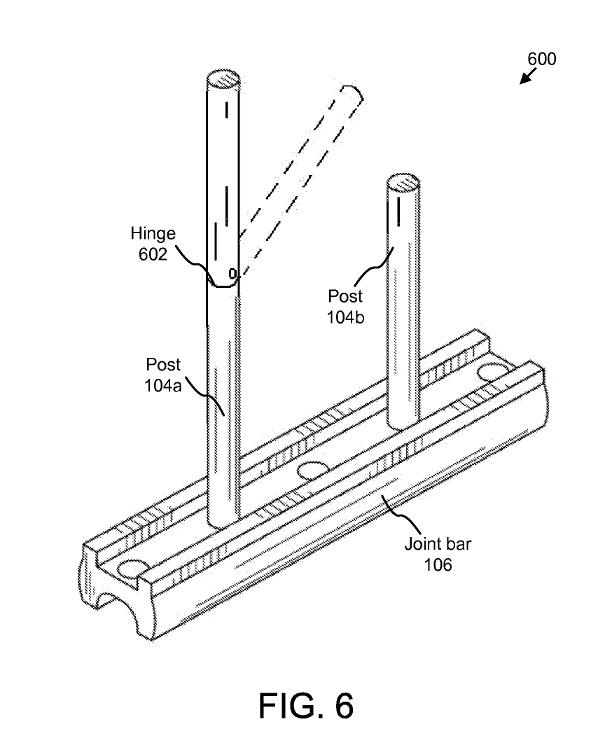

FIG. 6 is a side elevational perspective view of a joint bar securement device 600 in accordance with the present invention. The device 600 comprises a post 104a, a post 104b and a hinge 602.

As shown, the post 104a, the shown embodiment, extends to a greater height than the post 104b. The post 104a comprises a hinge 602 disposed on the post 104a at the same height as the post 104b. The upper section of the post 104a is hingedly affixed to the lower portion of the post 104a such that the upper section rotates about the hinge 602 downward and abuts the post 104b. The upper section of the post 104a, in the shown embodiment, is equivalent to the distance between post 104a and post 104b across the baseplate 102.

In some embodiments of the present invention, the upper section of the post 104a locks to the post 104b using means known to those of skill in the art, such that joint bars 106 strung over the posts 104a-b can be secured from bouncing off the device 600 by the upper section in locked position during transport.

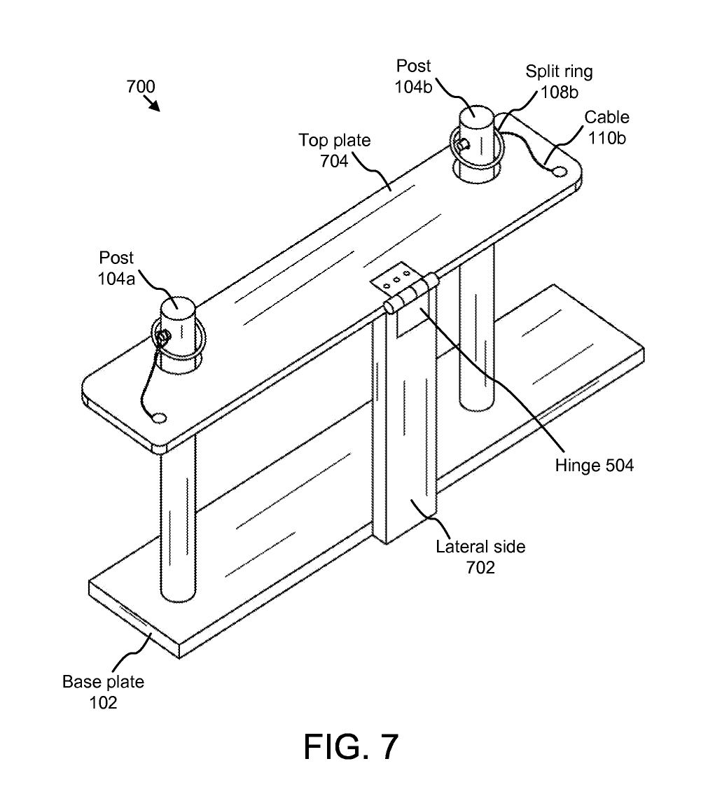

FIG. 7 is a side elevational perspective view of a joint bar securement device 700 in accordance with the present invention. The device 700 comprises a baseplate 102, posts 104a-b, a splitring 108b, a cable 110b, a lateral side 702, a hinge 504, and a top plate 704.

In the shown embodiment, the lateral side 702 is affixed to the baseplate 102 at a lateral edge of the baseplate 102. The lateral side 702 rises orthogonally from the top surface of the baseplate 102 in parallel with the posts 104a-b. The lateral side 702 sits out of the way of joint bars 106 strung onto the posts 104a-b, and serves the dual purpose of further securing the joint bars 106 by providing them lateral support, and also supporting the top plate 704, which is hingedly affixed to the lateral side 702, such that the top plate 704 can be locked over the top of the joint bars 106.

In the shown embodiment, the top plate 704 comprises apertures for receiving the distal ends of the posts 104a-b. The top plate 704 is locked down with split rings 108a-b affixed to the posts 104a-b. In some embodiments, cables 110a-b are affixed at a second end to the top plate 704 and detachably affixed at first end to either the posts 104a-b or the split rings 108a-b.

In some embodiments of the present invention, the top plate 704 is not affixed to the lateral side 702, and rather is held in place by the split rings 108a-b alone. In other embodiments, the top plate 704 is affixed to a plurality of lateral sides 702 rising from the baseplate 102. The device 700 may comprise more than one lateral side 702.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A joint bar securement device comprising:
a rigid metal baseplate having a planar top surface; and
a plurality of elongated cylindrical metal shafts rising orthogonally from the surface of the baseplate, the cylindrical shafts for threading through apertures defined by one or more joint bar(s), wherein a diameter of the cylindrical shafts is less than a diameter of the apertures defined by the joint bar(s), the joint bar(s) used in construction of railroad track, each of the metal shafts having have a proximal end affixed to the baseplate and an opposing distal end for penetrating joint bars threaded over the metal shafts.

2. The joint bar securement device of claim 1, wherein one or more of distal end(s) of the metal shaft(s) define(s) a distal aperture.

3. The joint bar securement device of claim 2, further comprising:
a split ring threaded through the distal aperture(s) defined by the metal shaft(s); and
one or more cable(s) affixed at one end to the baseplate and affixed detachably at an opposing end to one of the split rings to secure joint bars threaded over the metal shafts from bouncing off the metal shafts during transport.

4. The joint bar securement device of claim 1, further comprising an elongated crossbar detachably affixed at a first end to the distal end of one of the metal shafts, the crossbar also detachably affixed at a second end to one of the metal shafts.

5. The joint bar securement device of claim 4, wherein the apertures defined by the distal ends of the metal shafts receive and grip the crossbar.

6. The joint bar securement device of claim 1, further comprising a split ring detachably affixed to the distal end of a metal shaft.

7. The joint bar securement device of claim 1, further comprising one or more of a cable, chain, and rope affixed at one end to the baseplate and affixed at an opposing end to the distal end of one of the metal shafts.

8. The joint bar securement device of claim 1, further comprising a bar hingedly connected at a first end to the distal end of a first metal shaft, the bar lockably affixable at a second end to the distal end of a second metal shaft.

9. The joint bar securement device of claim 1, further comprising a bar hingedly connected at a first end to the distal end of a first metal shaft, the bar lockably affixable at a second end to the distal end of a second metal shaft.

10. The joint bar securement device of claim 1, wherein one of the metal shafts is slideably affixed to the baseplate such that a width between the metal shaft and other metal shafts is adjustable.

11. A joint bar securement device comprising:
a rigid metal baseplate having a planar top surface; and
an elongated cylindrical metal shaft rising orthogonally from the surface of the baseplate, the cylindrical shaft for threading through apertures defined by one or more joint bar(s), wherein a diameter of the cylindrical shaft is less than a diameter of the apertures defined by the joint bar(s), the joint bar(s) used in construction of railroad track, the metal shafts having have a proximal end affixed to the baseplate and an opposing distal end for penetrating joint bars threaded over the metal shafts;
a left lateral side affixed to the baseplate comprising an elongated plate of metal having an inner planar surface rising orthogonally from the surface of the baseplate, the left lateral side affixed to the baseplate;
a right lateral side affixed to the baseplate comprising an elongated plate of metal having an inner planar surface rising orthogonally from the surface of the baseplate, the right lateral side affixed to the baseplate;
wherein the left lateral side and right lateral side define a recess between them for receiving and securing a joint bar in the recess from moving laterally across the top surface of the baseplate.

12. A joint bar securement device comprising:
a rigid metal baseplate having a planar top surface;
a plurality of elongated cylindrical metal shafts rising orthogonally from the top surface of the baseplate, the cylindrical shafts for threading through apertures defined by one or more joint bar(s), wherein a diameter of the cylindrical shafts is less than a diameter of the apertures defined by the joint bar(s), the joint bar(s) used in construction of railroad track, each of the metal shafts having have a proximal end affixed to the baseplate and an opposing distal end for penetrating joint bars threaded over the metal shafts;
a lateral side affixed to the baseplate, the lateral side comprising a rectangular plate of metal disposed off-center of the baseplate having a proximal end affixed to the baseplate and an opposing distal end, the lateral side rising orthogonally away from the top surface of the baseplate;
one or more hinge(s) affixed to the distal end of the lateral side; and
a top plate affixed to the hinge(s), the top plate defining two or more recesses for receiving the distal ends of the metal shafts such that the top plate can be laid over joint bars threaded onto the metal shafts.

13. The joint bar securement device of claim 12, further comprising a split ring detachably affixed to the distal end of a metal shaft.

14. The joint bar securement device of claim 13, further comprising one or more cables detachably affixed at a first end to the split ring and affixed at a second end to the top plate.

15. The joint bar securement device of claim 12, further comprising one or more chains detachably affixed with a locking mechanism at a first end to distal end of a metal shaft, the chain(s) affixed at a second end to the top plate.
